(19) United States
(12) Patent Application Publication
(10) Pub. No.: US 2020/0256011 A1
(43) Pub. Date: Aug. 13, 2020

(54) RECONFIGURABLE COMBINATION SOLID AND PATTERNED BEDDING SYSTEMS AND MANUFACTURING PROCESSES

(71) Applicant: INDO COUNT INDUSTRIES LTD., Mumbai (IN)

(72) Inventor: Mohit Kumar JAIN, Maharashtra (IN)

(73) Assignee: INDO COUNT INDUSTRIES LTD., Mumbai (IN)

(21) Appl. No.: 16/348,185

(22) PCT Filed: May 2, 2019
(86) PCT No.: PCT/IN2019/050351

§ 371 Date: May 8, 2019

(30) Foreign Application Priority Data
May 3, 2018 (IN) 201821016767

(51) Int. Cl. D06P 5/30; A47G 9/02; B41J 3/407; D06P 5/24; D06P 7/00

(52) U.S. Cl. CPC D06P 5/30; A47G 9/0207; A47G 9/0261; A47G 9/0223; D06P 7/00; A47G 9/0238; A47G 9/0253; B41J 3/4078; D06P 5/007; A47G 9/0246

(57) ABSTRACT

The present invention provides reconfigurable bedding systems generally including one or more bedding components such as a duvet, duvet cover, comforter, quilt, pillow shams, or sheets such as a fitted sheet, at least one flat sheet, and a plurality of pillow cases. According to some example embodiments, each component of the bedding system is manufactured so that half of the component is a uniform color, a solid portion, and the other half includes a pattern, a patterned portion. The components can be arranged in a variety of layouts with either the solid portion or pattern portion of each component visible.

### CROSS-REFERENCE TO RELATED APPLICATION

This application is related to PCT Patent Application Serial No. PCT/IN2019/050351 filed May 2, 2019, which claims priority to Indian Provisional Patent Application Serial No. 201821016767 filed May 3, 2018, the entireties of which are hereby incorporated by reference herein.

### TECHNICAL FIELD

The present invention relates generally to the field of bedding such as sheets and pillow cases, pillow shams, duvets, duvet covers, comforters, quilts, and more particularly to reconfigurable combination solid and patterned bedding systems and manufacturing processes.

### BACKGROUND

Generally, there are two types bedding or sheets commonly available in the market place—solid sheets, which are a uniform color, and pattern sheets having a pattern or design printed on or woven into the sheet. These sheets are normally sold in sets including a fitted sheet, at least one flat sheet and a plurality of pillow cases, for example, two pillow cases in most cases. Generally, a bedding set will consist of either solid bedding or patterned bedding and not a combination of both. A customer who wishes to mix and match solid and patterned bedding to create a creative bedding system will generally need to buy an entire set of both solid and pattern bedding which incurs unnecessary cost and requires storage space to store the excess bedding.

In a similar manner, other bedding such as a duvet, duvet cover, comforter, quilt, pillow shams, etc. are typically provided in a solid uniform color or a pattern, and are typically configured for only a single configuration (e.g., how it's supposed to lay atop the mattress). Again, customers wishing to mix and match to create a creative bedding system will typically need to buy several bedding items (duvet, duvet cover, comforter, quilt, pillow shams, sheets, etc.) in order to provide the desired customization. In some cases, in order to obtain a sheet comprising a combination of two different color and/or patterns (e.g., solid with print, solid with solid, or print with solid), the desired solid and/or pattern fabrics or panels are cut appropriately and joined or attached together by stitching. One drawback is that a seam is defined where the two fabric panels are joined, which can be uncomfortable and irritating to a user, and for example, can be an eyesore and diminish the look of the bedding. Other drawback include that the additional processing and assembly of the joining of the fabrics adds to the costs and reduces the productivity.

Accordingly, it can be seen that needs exist for bedding systems that allow a user to combine both solid and pattern bedding without having to buy superfluous bedding. It is to the provision of bedding systems meeting these and other needs that the present invention is primarily directed.

### SUMMARY

In example embodiments, the present invention provides a bedding system generally including a fitted sheet, at least one flat sheet, and a plurality of pillow cases. Each component of the bedding system is manufactured so that half of the component is a uniform color, a solid portion, and the other half includes a pattern, a patterned portion. The components can be arranged in a variety of layouts with either the solid portion or pattern portion of each component visible.

In one aspect, the present invention relates to a bedding system comprising a fitted sheet wherein half of the fitted sheet is a solid color and half of the fitted sheet includes a visual or textual pattern; at least one flat sheet having a first end and second end and two sides, wherein half of the flat sheet is a solid color and half of the flat sheet includes a visual or textual pattern; and at least one pillow case having two sides wherein one side is a solid color and one side includes a visual or textual pattern; wherein both the first end and second end of the at least one flat sheet include a decorative hem.

In another aspect, the invention relates to a method of producing a bedding system comprising, printing a pattern into one half of a sheet of fabric of a solid color; cutting a fitted sheet, at least one flat sheet, and at least one pillow case from the sheet of fabric wherein the fitted sheet, the least one flat sheet, and the at least one pillow case are cut so that half is a solid color and half includes the printed pattern; and stitching a decorative hem into a first end and a second end of at least one flat sheet.

In another aspect, the invention relates to a bedding system including a bedding component having a front fabric and a back fabric, the front fabric and back fabric being attached together, wherein the front fabric includes a first pattern print and a first solid print and wherein the back fabric includes a second pattern print and a second solid print, wherein the bedding component is reconfigurable in at least four configurations when placed atop a bed and with an upper end thereof folded over towards the side of the fabric that is visible.

In example embodiments, the bedding component includes at least one components selected from a group consisting of a duvet, a duvet cover, a comforter, a quilt, a blanket, a fitted sheet, a flat sheet, a pillow case and/or a pillow sham.

In yet another aspect, the invention relates to a method of printing on a textile including providing a digital printing machine; providing a roll of unprinted fabric; feeding an end of the roll of unprinted fabric to a printing bed of a digital printing machine; traversing a printing head across a width of the fabric and applying an ink on a top side of the fabric; and incrementally moving the fabric that is atop the printing bed forward after the printing head completes one or more passes across the width of the fabric.

In example embodiments, a first half of the fabric includes a pattern printed thereon and a second half of the fabric is printed with a solid and uniform color.

In example embodiments, the fabric is cut to be used with at least one selected from a group consisting of a duvet, a duvet cover, a comforter, a quilt, a blanket, a fitted sheet, a flat sheet, a pillow case and/or pillow sham.

In another aspect, the invention relates to a method of printing on a textile including providing a rotary printing machine including a printing area including one or more printing roller assemblies, each roller assembly including an elongate screen component; providing a roll of unprinted fabric; and feeding an end of the roll of unprinted fabric to a printing area of a rotary printing machine and exposing a top or single side of the fabric to the elongate screen components, wherein each of the elongate screen components are divided at a midpoint thereof such that a first half of each screen is configured for printing atop a corresponding half of the fabric and a second half of each screen is configured for printing atop the other half of the fabric.

In example embodiments, the first half of the screen can be substantially open so as to produce a first side of the fabric that is solid dyed, and wherein the second half of the screen component can comprise one or more patterned openings so long that the solid dyed color and patterns are the same color. In example embodiments, the first half of the screen can be substantially open so as to produce a first side of the fabric that is solid dyed, and wherein the second half of the screen component is substantially closed or solid so as to prevent coloring or ink from being applied to a second side of the fabric that corresponds to the second half of the screen component.

In example embodiments, the first half of the screen can be closed or solid so as to prevent coloring or ink from being applied to a first side of the fabric that corresponds to the first half of the screen component, and wherein the second half of the screen component can comprise one or more patterned openings to be applied to a second side of the fabric. In example embodiments, the fabric is cut to be used with at least one selected from a group consisting of a duvet, a duvet cover, a comforter, a quilt, a blanket, a fitted sheet, a flat sheet, a pillow case and/or pillow sham.

In yet another aspect, the invention relates to a bedding system including a fitted sheet wherein half of the fitted sheet is a solid color and half of the fitted sheet includes a visual or textual pattern; at least one flat sheet having a first end and second end and two sides, wherein half of the flat sheet is a solid color and half of the flat sheet includes a visual or textual pattern; and at least one pillow case having two sides wherein one side is a solid color and one side includes a visual or textual pattern, wherein both the first end and second end of the at least one flat sheet include a decorative hem.

In another aspect, the invention relates to a method of producing a bedding system including printing a pattern into one half of a sheet of fabric of a solid color; cutting a fitted sheet, at least one flat sheet, and at least one pillow case from the sheet of fabric wherein the fitted sheet, the least one flat sheet, and the at least one pillow case are cut so that half is a solid color and half includes the printed pattern; and stitching a decorative hem into a first end and a second end of at least one flat sheet.

In example embodiments, the sheet of fabric has a thread count between 144 and 1000. In example embodiments, the decorative hem is one of a z-hem or double needle hem. In example embodiments, the pattern is printed using a reactive printing method. In example embodiments, the pattern is printed using a rotary printing machine. In example embodiments, the pattern is printed using a digital printing machine. In example embodiments, the method can further include further including providing a reconfigurable bedding component.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a reconfigurable combination solid and patterned bedding system according to an example embodiment of the present invention, the reconfigurable combination solid and patterned bedding system being in a first configuration.

FIG. 2 is a perspective view of the reconfigurable combination solid and patterned bedding system of FIG. 1, the reconfigurable combination solid and patterned bedding system being in a second configuration.

FIG. 3 is a perspective view of the reconfigurable combination solid and patterned bedding system of FIG. 1, the reconfigurable combination solid and patterned bedding system being in a third configuration.

FIG. 4 is a perspective view of the reconfigurable combination solid and patterned bedding system of FIG. 1, the reconfigurable combination solid and patterned bedding system being in a fourth configuration.

FIG. 5 is a plan view of preassembled fabric portions of the reconfigurable combination solid and patterned bedding system of FIG. 1.

FIG. 6 is a plan view of additional preassembled fabric portions of the reconfigurable combination solid and patterned bedding system of FIG. 1.

FIG. 7 is a perspective view of a reconfigurable combination solid and patterned bedding system according to another example embodiment of the present invention, the reconfigurable combination solid and patterned bedding system being in a first configuration.

FIG. 8 is a perspective view of the reconfigurable combination solid and patterned bedding system of FIG. 7, the combination solid and patterned bedding system being in a second configuration.

FIG. 9A is a top view of the bedding system of FIG. 7 in the first configuration.

FIG. 9B is a top view of the bedding system of FIG. 8 in the second configuration.

FIG. 9C is a top view of the bedding system of FIG. 8 in the third configuration.

FIG. 9D is a top view of the bedding system of FIG. 8 in the fourth configuration.

FIG. 9E is a top view of the bedding system of FIG. 8 in the fifth configuration.

FIG. 9F is a top view of the bedding system of FIG. 8 in the sixth configuration.

FIG. 9G is a top view of the bedding system of FIG. 8 in the seventh configuration.

FIG. 9H is a top view of the bedding system of FIG. 8 in the eighth configuration.

FIG. 9I is a top view of the bedding system of FIG. 8 in the ninth configuration.

FIG. 9J is a top view of the bedding system of FIG. 8 in the tenth configuration.

FIG. 10 is a perspective view of a digital printing machine according to an example embodiment of the present invention.

FIG. 11 is a top plan view of a printed-on roll of fabric according to an example embodiment of the present invention.

FIG. 12 is a top plan view of a printed-on roll of fabric according to another example embodiment of the present invention.

FIG. 13 is a side view of a rotary printing machine according to another example embodiment of the present invention.

FIG. 14 is a perspective view of a rotary screen of the rotary printing machine of FIG. 13.

FIG. 15 is a top view of the rotary screens of the rotary printing machine of FIG. 13, showing the rotary screens being in a first configuration according to an example embodiment of the present invention.

FIG. 16 is a top view of the rotary screens of the rotary printing machine of FIG. 13, showing the rotary screens being in a second configuration according to another example embodiment of the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Example embodiments of the present invention relate to a reconfigurable bedding system and to methods of making and using the same. In example embodiments, the bedding system can preferably be reconfigured to produce a plurality of different configurations, and thus, a plurality of different looks or styles can be provided with the same bedding system. According to example embodiments, the bedding system can comprise at least one bedding component selected from a group comprising a duvet, duvet cover, comforter, quilt, pillow sham(s), sheets (flat and/or fitted sheet), pillow case(s), etc. According to example embodiments, the at least one bedding component can comprise one or more solid and/or patterned portions, for example, which are generally applied to the fabric of the at least one bedding component by a printer. According to one example embodiment, the fabric of the at least one bedding component is printed on by use of a rotary printer. According to another example embodiment, the fabric of the at least one bedding component is printed on by use of a digital printer. In example embodiments, either of the rotary or digital printers can be configured so as to print fabric comprising both a solid portion and a patterned portion. In example embodiments, the solid portion and the patterned portion are arranged in separate halves along the length of the rolled fabric. In example embodiments, the bedding systems of the present invention preferably provide a user with many, many possibilities as to differing configurations of the various colors and patterns, etc. In example embodiments, the bedding systems of the present invention preferably save the user substantial space, for example, by providing multiple configurations with only one or two bedding systems.

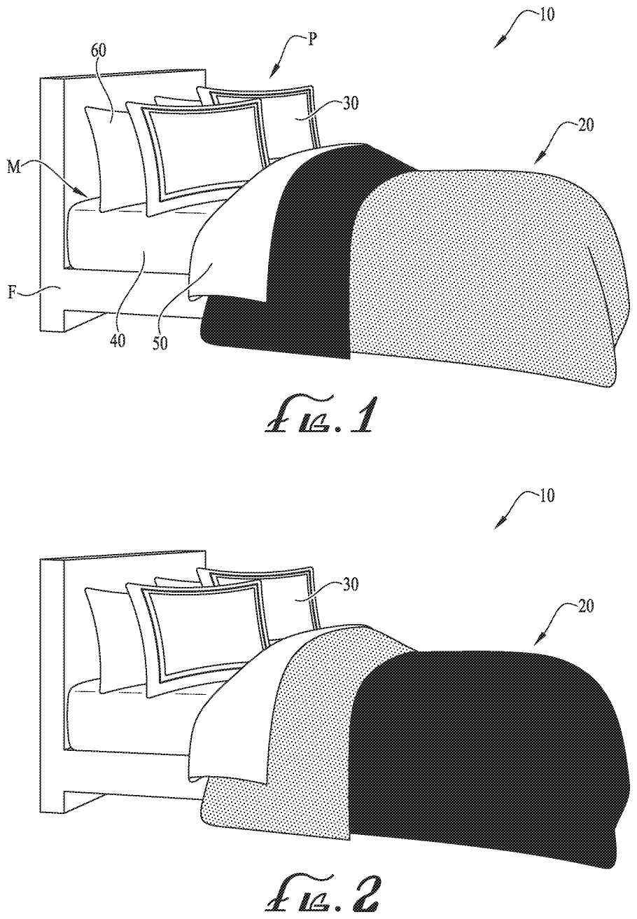

With reference now to the drawing figures, wherein like reference numbers represent corresponding parts throughout the several views, FIGS. 1-6 show a bedding system 10 comprising a plurality of configurations, for example, four configurations according to one example embodiment. For example, according to one example embodiment, a bedding system 10 for use with a bed or mattress M is depicted. In some example embodiments, the mattress M can be supported by a frame F or other supporting structure. According to other example embodiments, the mattress M can be positioned on a floor or ground surface, for example, in a home, a room of a home, on a porch and/or outside as desired.

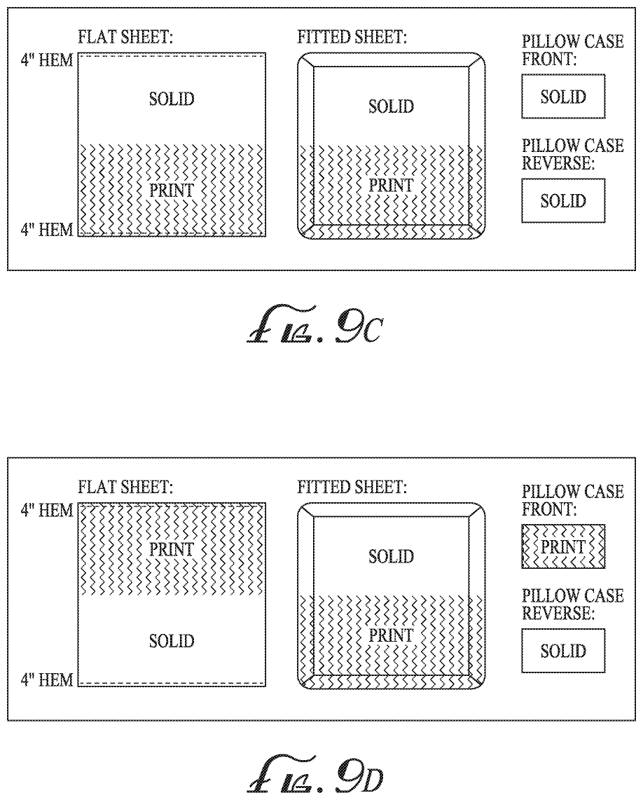

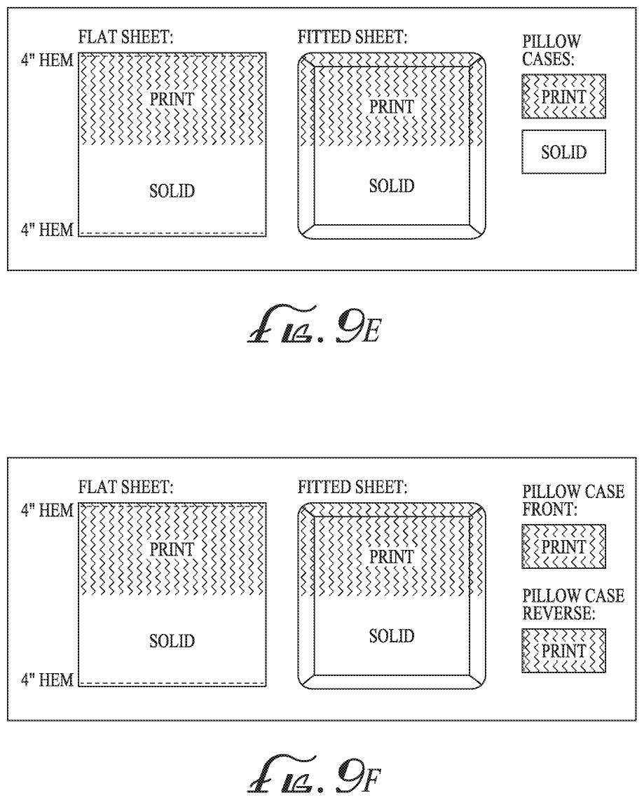

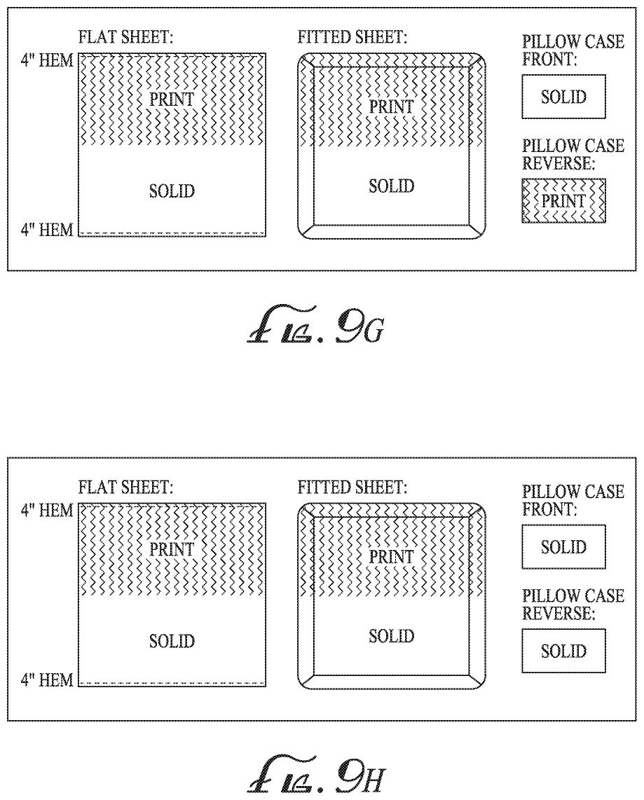

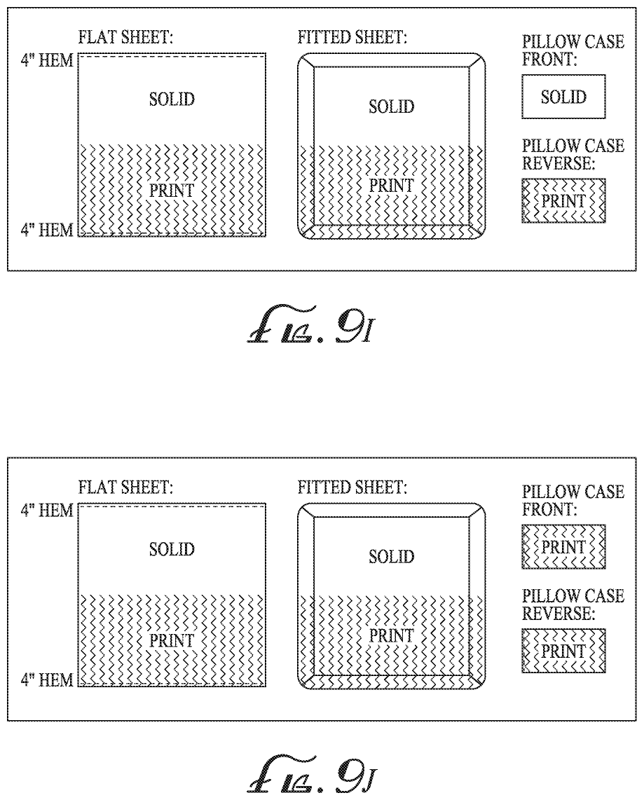

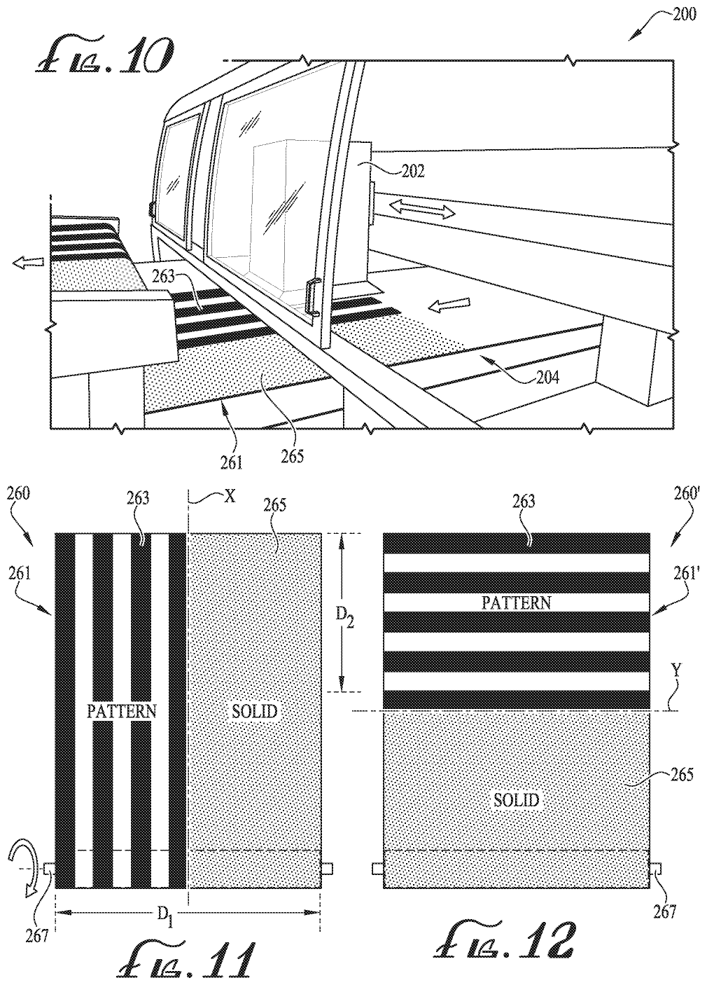

According to example embodiments of the present invention, the bedding system 10 generally comprises an outer duvet or duvet cover 20 for placement atop a fitted sheet 40 and a flat sheet 50 that are layered atop each other. According to other example embodiments, the outer duvet 20 can be in the form of a comforter, a quilt, a blanket or other cover. In example embodiments, the fitted sheet 40 is attached with the mattress M and the one or more pillows P can comprise a pillow sham 30 or pillow case 60 fitted thereon. As is depicted in FIGS. 1-4, the fitted sheet 40 and the flat sheet 50 are generally white or natural in color. According to some example embodiments of the present invention, as will be described below, various configurations of the bedding systems described herein are attainable at least with respect to the fitted and flat sheets 40, 50. Accordingly, the disclosure of the plurality of bedding systems can be incorporated together or can be interchangeable, for example, so as to provide even more customization of the look and feel of the resulting bedding system configuration. Thus, for example, the fitted and flat sheet 40, 50 configurations of FIGS. 9A-J can be incorporated with the fitted and flat sheet 40, 50 of the bedding system 10, as desired.

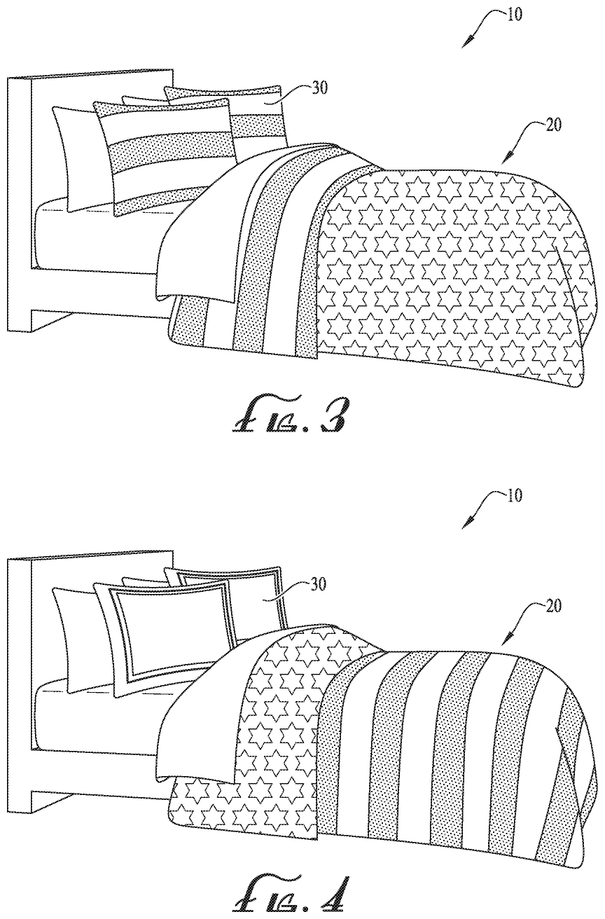

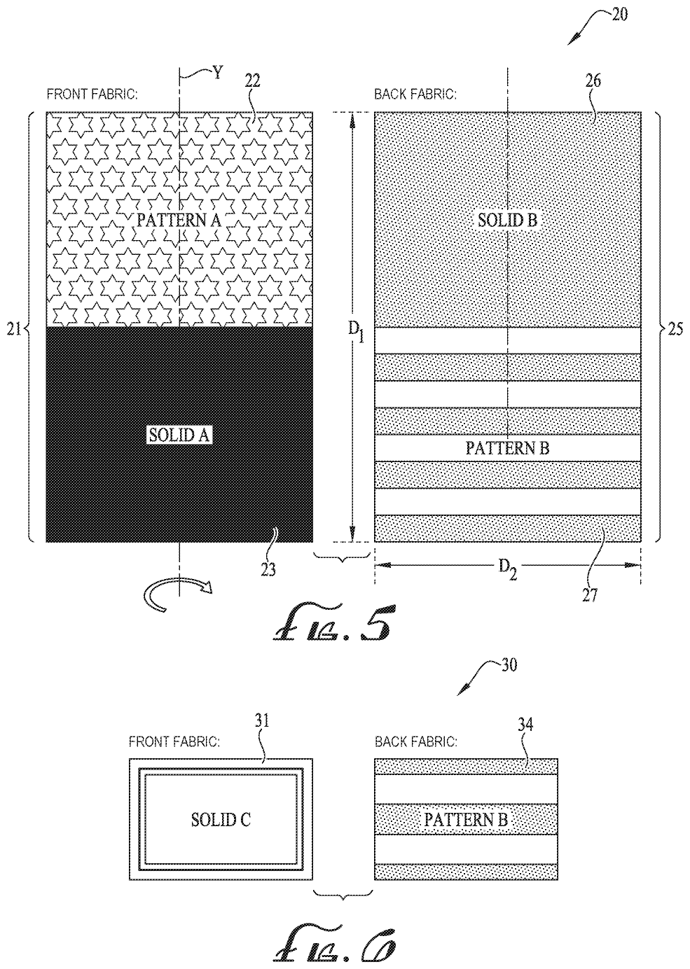

Referring back to FIGS. 1-4, the outer duvet 20 can be configured to lay atop the mattress M in at least four different ways or configurations, for example, wherein FIG. 1 depicts a solid B/solid A configuration, FIG. 2 depicts a solid A/solid B configuration, FIG. 3 depicts a pattern B/pattern A configuration, and FIG. 4 depicts a pattern A/pattern B configuration. As depicted in FIG. 5 and according to example embodiments, the outer duvet 20 comprises a front layer or front fabric 21 and a reverse or back layer or back fabric 25. As depicted, the front fabric 21 comprises a first patterned portion 22 (pattern A) printed on a first half of the front fabric 21 and a first solid portion 23 (solid A) is positioned on a second half of the front fabric 21. Similarly, the back fabric 25 comprises a second solid portion 26 (solid B) printed on a first half of the back fabric 25 and a second patterned portion 27 (pattern B) printed on a second half of the back fabric 25. In example embodiments, the front and back fabrics 21, 25 are generally sewn or attached together, for example, such that a rear side of the front fabric 21 is joined together with the rear side of the back fabric 25. For example, as depicted in FIG. 5, for joining the two fabrics 21, 25, the front fabric 21 is generally rotated 180 degrees about an axis Y, for example, which generally extends along the long side of the fabric 21 at its midpoint, and the back fabric 25 is placed atop the rear side of the front fabric 21 and generally with the outer edges or sides being aligned. The front and back fabrics 21, 25 can then be sewn together as desired. Thus, according to example embodiments of the present invention, the outer duvet 20 comprises a front fabric 21 and a back fabric 25, for example wherein the front 21 comprises a first half defining a patterned portion 22 and a second half defining a solid portion 23, and the back 25 comprises a first half defining a solid portion 26 and a second half defining a patterned portion 27. According to alternate example embodiments, the front and back fabrics 21, 25 can be configured so as to form a duvet cover, a comforter, a quilt, blanket or other covering.

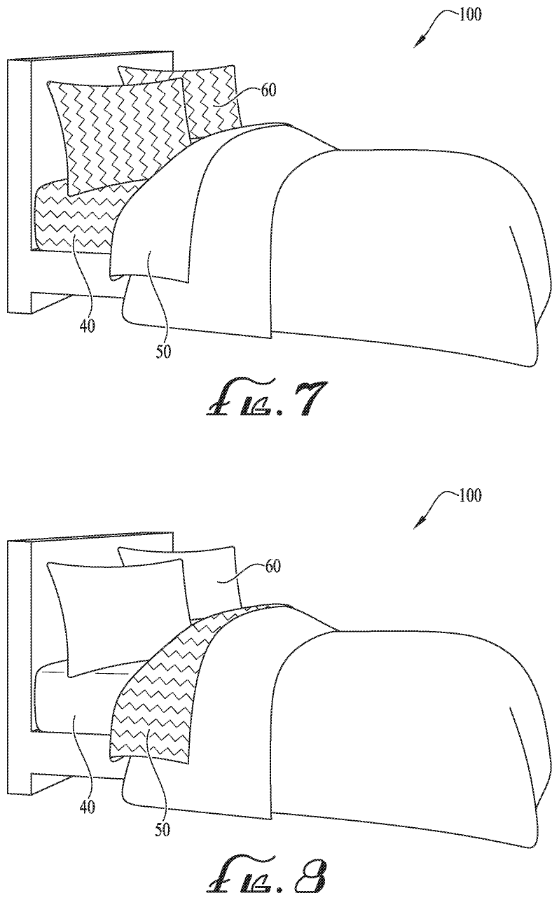

Similar to the outer duvet 20 comprising a front fabric 21 and a back fabric 25, the pillow sham or coverings 30 to be provided for covering at least one of the pillows P can comprise a front fabric 31 and a back fabric 34 (see FIG. 6). According to one example embodiment, the front fabric 31 comprises a solid portion (solid C) including one or more optional stitching/ornamental designs and the back fabric 34 comprises a patterned portion (pattern B). In a similar manner, the front and back fabrics 31, 34 are generally joined and sewn together, for example, to define a solid side and a pattern side, and with a pocket or opening for receiving a pillow P.

FIG. 1 depicts a solid B/solid A configuration (first configuration), for example, wherein the entirety of the solid portion 26 (solid B) of the first half of the back fabric 25 is displayed and covers a large portion of the mattress M. And the second half of the front fabric 21 is folded in half such that an upper end of the outer duvet 20 displays the solid portion 23 (solid A). In a similar manner, the outer duvet 20 can be reconfigured to the solid A/solid B configuration (second configuration), for example, which is generally opposite the configuration of the outer duvet 20 of FIG. 1. For example, as depicted in FIG. 2, the entirety of the solid portion 23 (solid A) of the second half of the front fabric 21 is displayed and covers a large portion of the mattress M. And the first half of the back fabric 25 is folded in half such that an upper end of the outer duvet 20 displays the solid portion 26 (solid B). According to example embodiments, the front fabric 31 of the pillow shams 30 is displayed when the outer duvet 20 is configured to display a solid/solid arrangement. In other example embodiments, the back fabric 34 of the pillow shams 30 can be displayed, or for example, one of the pillow shams 30 can be configured to display the front fabric 31 and another one of the pillow shams 30 can be configured to display the back fabric 34.

And as depicted in FIGS. 3-4, the outer duvet 20 is can optionally be reconfigured so as to provide a pattern B/pattern A configuration (third configuration) or a pattern A/pattern B configuration (fourth configuration). As depicted in FIG. 3, the third configuration is such that the entirety of the patterned portion 22 (pattern A) of the first half of the front fabric 21 is displayed and covers a large portion of the mattress M. And the second half of the back fabric 25 is folded in half such that an upper end of the outer duvet 20 displays the patterned portion 27 (pattern B). As depicted in FIG. 4, the fourth configuration is such that the entirety of the patterned portion 27 (pattern B) of the second half of the back fabric 25 is displayed and covers a large portion of the mattress M. And the first half of the front fabric 21 is folded in half such that an upper end of the outer duvet 20 displays the patterned portion 22 (pattern A). According to example embodiments and as depicted in FIG. 3, the back fabric 34 of the pillow shams 30 is displayed when the outer duvet 20 is in the third configuration. However, as depicted in FIG. 4, with the outer duvet 20 in the fourth configuration, the pillow shams 30 are configured so as to display the front fabric 31. In other example embodiments, either side of the pillow shams 30 can be displayed as desired.

According to example embodiments, the outer duvet 20 (and/or pillow shams 30) can comprise at least one or more solid and/or patterned portions, for example, such that the same can be displayed in multiple configurations to provide a plurality of different looks or appearances/design arrangements.

FIGS. 7-9J show a reconfigurable combination solid and patterned bedding system 100 according to an example embodiment of the present invention. In example embodiments, the bedding system 100 generally comprises a fitted sheet 40, at least one flat sheet 50, and one or more pillow cases 60. According to example embodiments, each component of the bedding system 100 is manufactured such that about half of the component is a uniform color or a solid portion, and the other half includes a pattern or a patterned portion. In other embodiments, the bedding system 100 can be manufactured so that each component includes two different solid color portions or two different pattern portions.

According to example embodiments, the fitted sheet 40 comprises a solid portion 42 and a pattern portion 44, for example, which is configured such that either the solid portion 42 or the pattern portion 44 is positioned at the top of the sheet while the other portion is positioned at the bottom, as shown in FIG. 9A. In example embodiments, the fitted sheet 40 comprises can be placed on the bed or mattress M with either the solid portion 42 or the pattern portion 44 oriented to the top of the bed. The portion oriented to the top of the bed will generally be visible while the portion oriented to the bottom of the bed will be obscured by other bedding (e.g., and thus hidden from visibility). Therefore, a user can choose whether to display the patterned portion or the solid portion of each bedding component simply by adjusting or reversing its orientation.

The flat sheet 50 comprises a solid portion 52 and a patterned portion 54 that are configured similar to the fitted sheet. In example embodiment, both ends of the flat sheet 50 can include a top or decorative hem 56 so that both portions can be oriented toward the top of the bed. The hem 56 can be a “z” hem, double needle hem, or any other hem or decorative hem. In some example embodiments, the hems 56 are stitched with a manual folder to increase consistency. And the pillow cases 60 as similarly configured to comprise a solid portion 62 on one side of the pillow case and a pattern portion 64 on the other side thereof. The pillow cases 60 can be oriented such that either the solid portion 62 or the patterned portion 64 faces outward and is visible to the user.

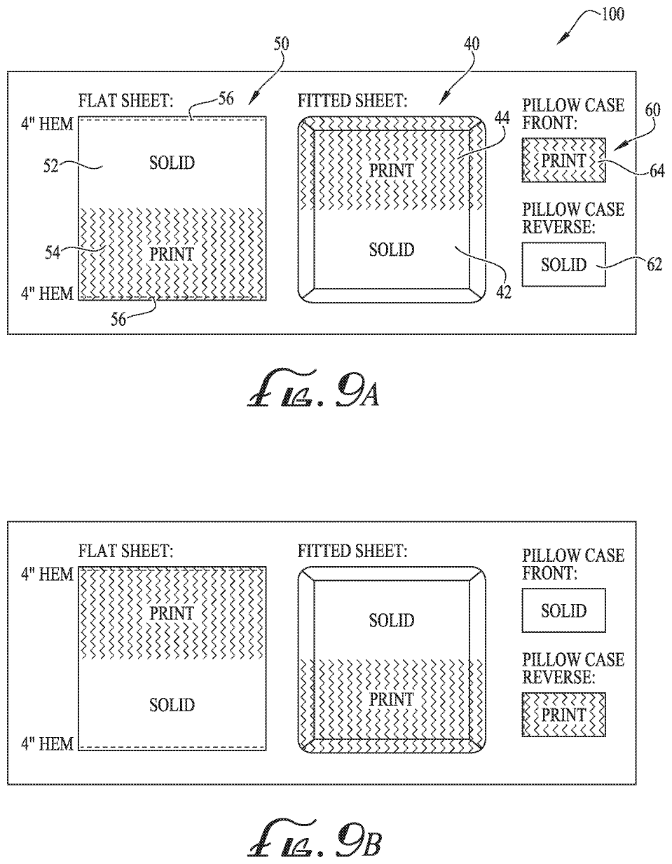

For example, according to some example embodiments, FIG. 7 depicts the bedding system in a first configuration with the pattern portion 44 of the fitted sheet 40 and the solid portion 52 of the flat sheet 50 oriented towards the top of the bed. And the pillow cases 60 are arranged such that the pattern portion 64 is visible. In example embodiments, the first configuration of the bedding system 100 is similarly depicted in FIG. 9A. According to another example embodiment, FIG. 8 depicts the bedding system 100 in a second configuration with the solid portion 42 of the fitted sheet 40 and the pattern portion 54 of the flat sheet 50 oriented towards the top of the bed. And the pillow cases 60 are arranged such that the solid portion 62 is visible. In example embodiments, the second configuration of the bedding system 100 is similarly depicted in FIG. 9B. According to example embodiments, the bedding system 100 can also be configured in a plurality of other configurations as desired. For example, FIG. 9C depicts a third configuration, FIG. 9D depicts a fourth configuration, FIG. 9E depicts a fifth configuration, FIG. 9F depicts a sixth configuration, FIG. 9G depicts an seventh configuration, FIG. 9H depicts a eighth configuration, FIG. 9I depicts a ninth configuration and FIG. 9J depicts a tenth configuration. And as similarly discussed above, the bedding system 100 can preferably be incorporated for use with the bedding system 10 as desired, for example, so as to provide a plurality of additional configurations.

According to example embodiments, the components of the bedding systems 10, 100 can be formed from any desired materials such as cotton, sateen, twill, flannel, silk, polyester, synthetic materials, natural materials, or any other bedding materials or combinations thereof. In some example embodiments, the components are formed from 100% cotton. In other embodiments, the components are formed from a fabric formed of cotton blended with polyester, wool, viscose, modal, tencel, excel, acrylic or another bedding material. According to example embodiments, the fabric count is generally greater than 144, for example, with the components having a thread count between about 144 and about 1000. According to one example embodiment, one or more of the components are formed from fabric with a thread count above 1000.

According to example embodiments, the solid and pattern portions of the bedding systems 10, 100 can preferably be chosen and configured as desired. According to preferred example embodiments, the solid and/or pattern portions can be comprised of one or more colors. For example, according to example embodiments, each solid portion is generally entirely a single uniform color, and for example, the pattern portions can be comprised of any desired pattern comprising one or more colors. According to some example embodiments, the one or more pattern portions include dobby stripes, sateen stripes, or another textural pattern. Optionally, other images, graphics, illustrations, symbols, lines, indicia, or other items can be applied to the fabric of the pattern portions as desired. For example, according to the depicted embodiments, the pattern portions can include stripes, stars and zigzag lines. According to some example embodiments, the pattern portions can be directional and/or non-directional as desired.

As will be described in greater detail below, the solid and pattern portions of the bedding systems 10, 100 can be printed on the fabrics or sheets thereof. According to example embodiments, a digital printing machine or rotary printing machine can be provided so as to print one or more solid and/or pattern portions of the fabrics of the bedding systems 10, 100. In alternate example embodiments, the fabrics can be woven/yarn dyed so as to produce a desired color/pattern. According to other example embodiments, other printers or other means for applying a desired side-by-side configuration can be provided as desired. According to some example embodiments, side-by-side printing can produce two solid colored or dyed portions, a solid portion and a pattern portion, or two patterned or non-dyed portions. Optionally, other printing configurations comprising one or more solid and/or pattern portions can be provided so as to apply the same to the fabric. According to example embodiments, by printing the solid and pattern portions, the look is substantially improved, production costs are reduced, and productivity is increased.

For example, FIG. 10 shows a digital printer 200 according to an example embodiment of the present invention. As depicted, the digital printer 200 comprises a traversable printing head 202 and a printing bed 204 positioned below the printing head 202 for moving natural colored fabric in a direction generally transverse the traversable printing head 202. In example embodiments, fabric 261 passes along the printing bed 204 while the printing head 202 traverses from side-to-side, applying a desired print on a top or single side of the fabric 261. According to one example embodiment, the digital printer 200 comprises a JPK EVO 7 digital textile printer by MS Printing Solutions (MS ITALY). In example embodiments, the productivity of the printer 200 is about 1410 square meters per hour. According to one example embodiment, the printing resolution is about 600×600 dpi with up to 32 printing heads and a printing width up to about 320 centimeters (125.984 inches, 10.5 feet). In alternate embodiments, other digital printing machines can be provided as desired, and for example, can be configured to provide a desired productivity, resolution, printing head capacity, and/or other features or components as desired. According to one example embodiment, the digital printer 200 can be configured for mono direction, single row printing, for example, so as to maximize the ink penetration.

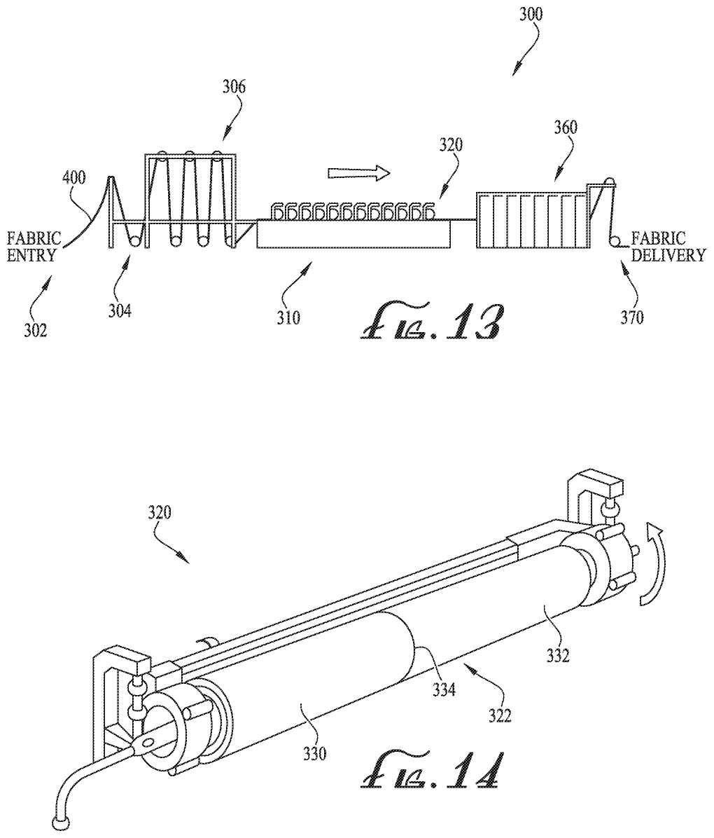

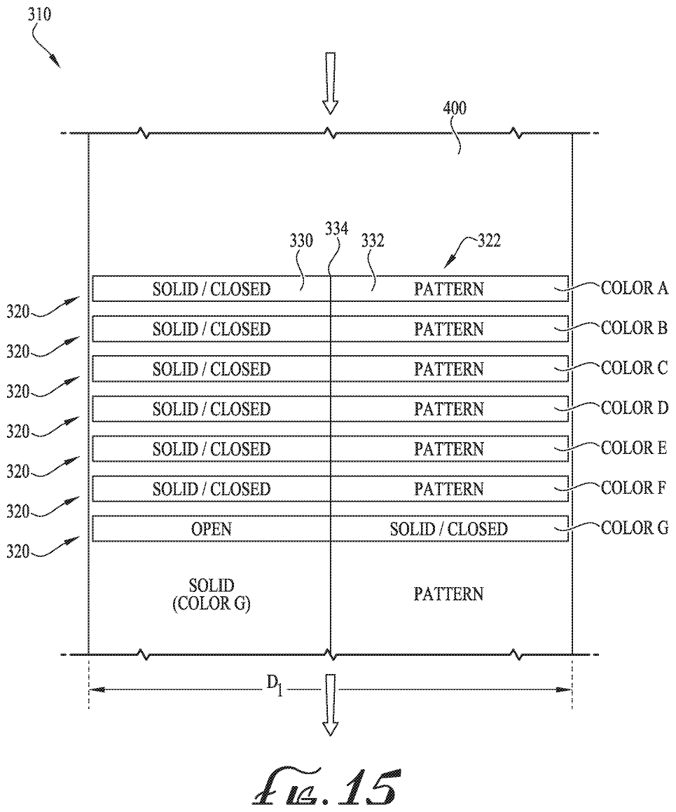

FIG. 11 shows a roll of printed fabric 260 according to an example embodiment of the present invention. As shown, the roll of printed fabric 260 comprises the printed fabric 261 that is rolled around an elongate cardboard core 267, for example, which can act as the foundation for retaining the rolled fabric thereon. According to example embodiments of the present invention, rolls of fabric which are to be processed through printing can comprise anywhere from about 100 yards to about 3,000 yards of fabric rolled around the cardboard core and itself. In example embodiments, the printed fabric 261 comprises a first half 263 and a second half 265. As depicted, the first half 263 comprises a pattern print applied thereon and the second half 265 comprises a solid print applied thereon. In example embodiments, the first and second halves 263, 265 are positioned on opposite sides of a midpoint (see X-axis) of the fabric's 261 width D1. According to example embodiments, the fabric 261 comprises a width D1 of about 120 inches, for example, with about 60 inches of the width being defined between the X-axis and a side or selvedge edge thereof, and wherein about 60 inches are defined between the X-axis and the other side or selvedge edge thereof. In other example embodiments, the width D1 of the fabric 261 can be more than about 120 inches, or for example, the width D1 can be less than about 120 inches.

According to one example embodiment, a natural colored fabric roll comprising about 1,500 yards of fabric with selvedge outer sides or edges can be processed through the printing machines as described herein. Thus, according to example embodiments of the present invention, the pre-printed fabric roll that is to be printed on can be fabric which is a natural color due to the fabric not being treated color-wise prior to the printing process, and thus the color is based upon the natural color of the fibers of the fabric. According to alternate example embodiments, a fabric comprising at least some color alteration and/or feature(s) and/or other treatment(s) can be similarly processed through the printing machines as described herein.

With reference back to FIG. 10, as the printer head 202 moves from side-to-side across the width D1 of the fabric 261, the first half 263 is provided with the pattern print, and for example, on the other side of the X-axis, the second half 265 is provided with the solid print. Thus, according to example embodiments of the present invention, the digital printing machine 200 is configured so as to apply one or more pattern portions and/or one or more solid portions on the fabric 261, for example, side-by-side, as it moves along the printer bed 204. According to the depicted embodiment, the digital printing machine 200 preferably provides for printing at least two dissimilar solid and/or pattern portions of one or more colors along the width of the fabric 261. Once the digital printing machine 200 has completed printing on the fabric 261, the roll of printed fabric 260 can be further processed as desired.

According to one example embodiment, the roll of printed fabric 261 is processed whereby sections of the printed fabric 261 are generally cut, for example, so as to be sewn together or finished for use as one or more components of the bedding systems 10, 100. For example, with reference back to FIG. 5, the short side of the top and back fabrics 21, 25 defines a width D2. Thus, with reference back to FIG. 11, an unrolled portion of the printed fabric 261 of the roll of printed fabric 260 can be cut by a dimension D2 from the free end of the printed fabric 261, for example, to produce the top and back fabrics 21, 25. Indeed, as depicted in FIG. 5, the top and back fabrics comprise different solid and pattern portions, and thus, sections of two different printed fabrics are needed to produce the outer duvet 20.

In alternate embodiments, the digital printing machine 200 can print the one or more solid and/or pattern portions on the fabric in other configurations, for example, instead of only providing a side-by-side printing arrangement where one side of the fabric from an outer selvedge edge thereof to the midpoint (e.g., X-axis) is one of a solid or pattern portion and the other side of the fabric from the other outer selvedge edge thereof to the midpoint is the other of a solid or pattern portion. For example, FIG. 12 shows a roll of printed fabric 260′ according to another example embodiment. As depicted, the printed fabric 261′ comprises alternating printed portions, for example, rather than the side-by-side printing arrangement. As such, in the case of the printed fabric 261′ of FIG. 12, the digital printing machine 200 is configured to print one of a solid or pattern portion across the entire width D1 of the fabric for a desired length, and then for example, the digital printing machine alternates the print and applies the other of the solid or pattern portion across the entire width D1 of the fabric for a desired length. Accordingly, in a similar manner as described above, the printed fabric 261′ can be cut so as to be used with one or more components of the bedding systems 10, 100.

According to example embodiments, a Y-axis is defined along the intersection of the pattern and solid sections 263, 265, for example, which is perpendicular to the X-axis that is separating the pattern and solid portions (see FIG. 12). According to one example embodiment, the length in which the pattern and solid portions extend would generally be such that the dimension would provide a cut-ready solution without much, if any, waste. For example, whether the outer duvet 20 is to be configured for fitting a twin, full, queen, king size mattress, adjustments can be made within the software and/or operating software and settings such as to provide adjustment to the length for which the pattern and solid portions extend. According to one example embodiment, the length of each of the alternating pattern and solid portions is substantially similar to the width D1 of the roll 260 (see FIG. 11). In other example embodiments, the extension of the pattern and solid segments can be configured as desired.

According to another example embodiment of the present invention, a rotary printing machine 300 can provided to apply one or more solid and/or pattern portions on fabric 400 or sheet material of the components of the bedding systems 10, 100. According to some example embodiments, the rotary printing machine 300 comprises a Zimmer Rotary printing machine (model numbers: TG_58 & TG_211). Optionally, other rotary printing machines can be provided as desired.

In example embodiments, the rotary printing machine 300 generally comprises a fabric entry end 302, for example, wherein a roll of unprinted, natural fabric is unrolled to pass through a J frame 304, a cleaning area 306, a printing area 310 comprising one or more printing roller assemblies 320, a drying and curing stage 360, and exiting at a fabric delivery end 370, for example, wherein the fabric can be rolled up to provide a roll of printed fabric for further processing. In other example embodiments, the fabric delivery end 370 is configured so as to fold the printed fabric 400, or for example, evenly and loosely disperse the finished printed fabric within a container or other containment apparatus.

FIG. 14 shows a printing roller assembly 320 in greater detail. In example embodiments, the assembly 320 comprises an elongate and generally cylindrical screen component 322 that is rotatably mounted to portions of the roller assembly 320. In example embodiments, each screen component 322 can comprise one or more components such as a squeegee blade, a level controller, print paste feed component and/or other components such that the paste, ink, dye or other colored composition can be fed within the screen component 322 and the squeegee therein can assist in the application of the colored composition on the fabric 400, for example, wherein the colored composition is pressed through the one or more openings of the screen component 322 on to the fabric, for example, while the fabric 400 is moving across the printing area 310 and underneath the one or more printing roller assemblies 320. According to example embodiments, the colored composition (e.g., ink, dye, or other coloring) is applied to a top or single side of the fabric 400.

According to example embodiments, the screen component 322 can be configured such that about half of the screen component comprises a first configuration and the other half of the screen component comprises a second configuration. For example, to provide a printed fabric comprising one or more solid portions and one or more pattern portions, for example, as similarly depicted in FIG. 11, each of the screen components 322 are generally halved, or for example, are customized so as to define a midpoint 334 at about one half of the length of the entire component 322 such that the screen component 322 is generally divided into two portions. According to example embodiments, the screen components can comprise a first portion 330 and a second portion 332, for example, wherein the midpoint 334 is generally defined exactly between the first and second portions 330, 332. As such, depending on the particular desired resulting fabric, the first and second portions 330, 332 of each of the screen components 332 of the one or more roller assemblies 320 can be configured so as to produce the desired printed fabric.

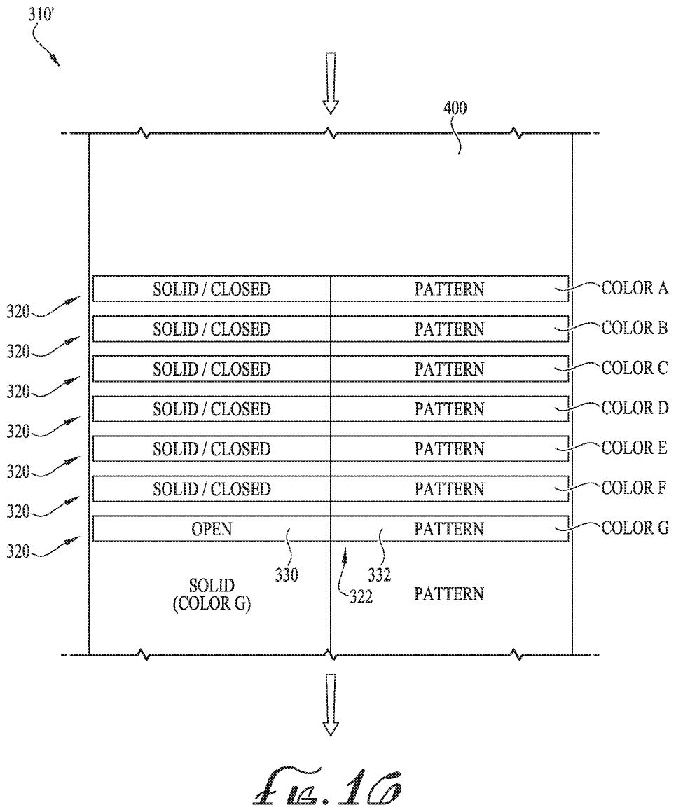

For example, FIG. 15 shows a printing area 310 comprising seven roller assemblies 320 rotatably mounted thereto in a spaced-apart configuration for applying desired side-by-side solid and pattern portions to the fabric 400. According to the depicted example, the first six screen components 322 are configured for only applying portions of the pattern to the fabric. Thus, as shown, the first portions 330 are solid without any engraving (e.g., no openings present), and thus no colored composition is permitted to be applied to the corresponding side of the fabric. However, the second portions 332 of the first six screen components 322 are each engraved with the desired pattern (e.g., openings present) such that the pattern is applied to the corresponding side of the fabric in each of colors A-F. And the seventh screen component 322 is configured such that the first portion 330 is engraved so as to provide uniform openings about the entirety thereof, and the second portion 332 is solid without any engraving. Thus, according to example embodiments, the seventh screen component 322 is provided for applying a uniform solid portion on a side of the fabric 400 that is generally opposite the side of the fabric 400 comprising the pattern portion.

According to the example embodiment as depicted in FIG. 15, it should be noted that the configuration of the screen components 322 is such that the pattern portion comprises colors A-F and the solid portion comprises color G. Thus, when the color of the solid portion is not common with any of the colors of the pattern portion, a separate screen component 322 is provided, for example, which is configured with the first portion 330 being entirely open (e.g., for uniform application of solid color) and with the second portion 332 being entirely solid without any openings to prevent the solid color from being applied to the side comprising the pattern portion. As similarly described above, the fabric 400 comprises the width D1, which for example, can be about 120 inches. Optionally, the width D1 of the fabric 400 can be more or less than 120 inches as desired. For example, according to one example embodiment, the width D1 is between about 120-126 inches. According to another example embodiment, the width D1 is 120 inches. According to another example embodiment, the width D1 is 126 inches.

According to another example embodiment, the color of the solid portion can be one of the same colors that is also used in the pattern portion, and thus, the screen components 322 can be configured differently to the printing area 310. For example, FIG. 16 depicts a printing area 310′ comprising seven roller assemblies 320 rotatably mounted thereto in a spaced-apart configuration for applying desired side-by-side solid and pattern portions to the fabric 400. According to the depicted example, the first six screen components 322 are configured for only applying portions of the pattern to the fabric. Thus, as shown, the first portions 330 are solid without any engraving (e.g., no openings present), and thus none of the colored composition is permitted to be applied to the side of the fabric corresponding to the first portions 330. However, the second portions 332 of the first six screen components 322 are each engraved with the desired pattern (e.g., openings present) such that the pattern is applied to the corresponding side of the fabric in each of colors A-F. In example embodiments, the color of the solid portion and pattern portion is identical, and thus, the screen component 322 can be configured such that the first portion 330 is engraved so as to provide uniform openings about the entirety thereof, and the second portion 332 is engraved with the desired pattern (e.g., openings present). Thus, according to example embodiments, the seventh screen component 322 comprises openings formed through both the first and second portions 330, 332, for example, wherein one of the portions 330, 332 is substantially open so as to permit uniform application of the colored composition on one side of the fabric 400 (e.g., solid portion), and wherein the other of the portions 330, 332 is at least partially engraved to comprise one or more openings so as to permit application of the colored composition on the other side of the fabric (e.g., pattern portion).

According to example embodiments, the rotary printing machine 300 can preferably be configured as desired so as to produce a fabric comprising side-by-side dissimilar prints or solid/pattern configurations. In example embodiments, the dissimilar prints or solid/pattern configurations are printed side-by-side such that the dissimilar pattern prints or solid portions are generally parallel relative to each other and extending along the length of the fabric 400 (e.g., the direction of the length of the fabric being transverse to the width D1). In example embodiments, each of the screen components is substantially cylindrical and elongate, for example, extending about 120 inches. Optionally, screen components can be longer or shorter than 12) inches as desired. In example embodiments, the mesh or openings of the screen components 322 are preferably substantially similar for each of the roller assemblies 320 so as to maintain the color consistency between the ends of each screen component 322.

According to some example embodiments, other machine settings and components can be configured as desired, for example wherein maximum new screen components are used to avoid dent marking during rotary printing with even mesh size (e.g., openings), extra care is provided in the pretreatment process to enhance the solidity of the print application, the color viscosity consistency is maintained by avoiding color bards during printing, and a color sensor can be incorporated within the printing area 310 so as to monitor and prevent the occurrence of color chock-up. According to example embodiments, the color sensor is set on an operator side of the machine. According to some example embodiments, the first portion 330 of the screen component 322 is configured to apply the solid portion, for example, which is similarly arranged to be positioned on the operator side of the machine. According to one example embodiment, the solid portion is configured to be on the left side of the rotary printing machine, and thus, the left side half of the fabric 400 (e.g., as depicted in FIGS. 15-16). Optionally, the solid and pattern portions can be arranged as desired.

According to one preferred example embodiment, the rotary printing machine 300 can be configured such that the repeat size is between about 2.8-3 meters, for example, rather than about 1 meter as is the limit for typical machines. According to one example embodiment, the rotary printing machine 300 comprises a repeat size of 2.8 meters. Optionally, the rotary printing machine 300 can comprise a repeat size of between about 1-4 meters. According to some example embodiments, the rotary printing machine 300 comprises up to about twenty screen components 322, and thus, up to about twenty roller assemblies 320. In other example embodiments, the rotary printing machine 300 can comprise about sixteen screen components 322, or for example, about seven screen components 322 (see FIGS. 15-16). In other example embodiments, the rotary printing machine 300 comprises at least one screen component 322.

According to additional example embodiments, other printing methods such as screen printing, flat bed printing, and/or other desired printing methods and processes can be configured so as to provide the printed fabrics as described herein.

According to another example embodiment, the present invention relates to a method of printing on a textile comprising providing a digital printing machine; providing a roll of unprinted fabric; feeding an end of the roll of unprinted fabric to a printing bed of a digital printing machine; traversing a printing head across a width of the fabric and applying an ink on a top side of the fabric; and incrementally moving the fabric that is atop the printing bed forward after the printing head completes one or more passes across the width of the fabric. In example embodiments, a first half of the fabric comprises a pattern printed thereon and a second half of the fabric is printed with a solid and uniform color. In example embodiments, the fabric is cut to be used with at least one selected from a group consisting of a duvet, a duvet cover, a comforter, a quilt, a blanket, a fitted sheet, a flat sheet, a pillow case and/or pillow sham.

According to another example embodiment, the present invention comprises a method of printing on a textile comprising providing a rotary printing machine comprising a printing area comprising one or more printing roller assemblies, each roller assembly comprising an elongate screen component; providing a roll of unprinted fabric; and feeding an end of the roll of unprinted fabric to a printing area of a rotary printing machine and exposing a top or single side of the fabric to the elongate screen components, wherein each of the elongate screen components are divided at a midpoint thereof such that a first half of each screen is configured for printing atop a corresponding half of the fabric and a second half of each screen is configured for printing atop the other half of the fabric.

In example embodiments, the first half of the screen can be substantially open so as to produce a first side of the fabric that is solid dyed, and wherein the second half of the screen component can comprise one or more patterned openings so long that the solid dyed color and patterns are the same color. In example embodiments, the first half of the screen can be substantially open so as to produce a first side of the fabric that is solid dyed, and wherein the second half of the screen component is substantially closed or solid so as to prevent coloring or ink from being applied to a second side of the fabric that corresponds to the second half of the screen component. In example embodiments, the first half of the screen can be closed or solid so as to prevent coloring or ink from being applied to a first side of the fabric that corresponds to the first half of the screen component, and wherein the second half of the screen component can comprise one or more patterned openings to be applied to a second side of the fabric. In example embodiments, the fabric is cut to be used with at least one selected from a group consisting of a duvet, a duvet cover, a comforter, a quilt, a blanket, a fitted sheet, a flat sheet, a pillow case and/or pillow sham.

According to another example embodiment as described above, the present invention relates to a bedding system comprising a fitted sheet wherein half of the fitted sheet is a solid color and half of the fitted sheet comprises a visual or textual pattern; at least one flat sheet having a first end and second end and two sides, wherein half of the flat sheet is a solid color and half of the flat sheet comprises a visual or textual pattern; and at least one pillow case having two sides wherein one side is a solid color and one side comprises a visual or textual pattern, wherein both the first end and second end of the at least one flat sheet include a decorative hem.

According to another example embodiment, the present invention relates to a method of producing a bedding system comprising printing a pattern into one half of a sheet of fabric of a solid color; cutting a fitted sheet, at least one flat sheet, and at least one pillow case from the sheet of fabric wherein the fitted sheet, the least one flat sheet, and the at least one pillow case are cut so that half is a solid color and half comprises the printed pattern; and stitching a decorative hem into a first end and a second end of at least one flat sheet. In example embodiments, the sheet of fabric has a thread count between 144 and 1000. In example embodiments, the decorative hem is one of a z-hem or double needle hem. In example embodiments, the pattern is printed using a reactive printing method. In example embodiments, the pattern is printed using a rotary printing machine. In example embodiments, the pattern is printed using a digital printing machine. In example embodiments, the method can further include further comprising providing a reconfigurable bedding component.

While the invention has been described with reference to example embodiments, it will be understood by those skilled in the art that a variety of modifications, additions and deletions are within the scope of the invention, as defined by the following claims.

What is claimed is:

1. A bedding system comprising a bedding component having a front fabric and a back fabric, the front fabric and back fabric being attached together, wherein the front fabric comprises a first pattern print and a first solid print and wherein the back fabric comprises a second pattern print and a second solid print, wherein the bedding component is reconfigurable in at least four configurations when placed atop a bed and with an upper end thereof folded over towards the side of the fabric that is visible.

2. The bedding system of claim 1, wherein the bedding component comprises at least one selected from a group consisting of a duvet, a duvet cover, a comforter, a quilt, a blanket, a fitted sheet, a flat sheet, a pillow case and/or a pillow sham.

3. A method of printing on a textile comprising:
providing a digital printing machine;
providing a roll of unprinted fabric;
feeding an end of the roll of unprinted fabric to a printing bed of a digital printing machine;
traversing a printing head across a width of the fabric and applying an ink on a top side of the fabric; and
incrementally moving the fabric that is atop the printing bed forward after the printing head completes one or more passes across the width of the fabric.

4. The method of claim 3, wherein a first half of the fabric comprises a pattern printed thereon and a second half of the fabric is printed with a solid and uniform color.

5. The method of claim 3, wherein the fabric is cut to be used with at least one selected from a group consisting of a duvet, a duvet cover, a comforter, a quilt, a blanket, a fitted sheet, a flat sheet, a pillow case and/or pillow sham.

6. A method of printing on a textile comprising:
providing a rotary printing machine comprising a printing area comprising one or more printing roller assemblies, each roller assembly comprising an elongate screen component;
providing a roll of unprinted fabric; and
feeding an end of the roll of unprinted fabric to a printing area of a rotary printing machine and exposing a top or single side of the fabric to the elongate screen components, wherein each of the elongate screen components are divided at a midpoint thereof such that a first half of each screen is configured for printing atop a corresponding half of the fabric and a second half of each screen is configured for printing atop the other half of the fabric.

7. The method of claim 6, wherein the first half of the screen can be substantially open so as to produce a first side of the fabric that is solid dyed, and wherein the second half of the screen component can comprise one or more patterned openings so long that the solid dyed color and patterns are the same color.

8. The method of claim 6, wherein the first half of the screen can be substantially open so as to produce a first side of the fabric that is solid dyed, and wherein the second half of the screen component is substantially closed or solid so as to prevent coloring or ink from being applied to a second side of the fabric that corresponds to the second half of the screen component.

9. The method of claim 6, wherein the first half of the screen can be closed or solid so as to prevent coloring or ink from being applied to a first side of the fabric that corresponds to the first half of the screen component, and wherein the second half of the screen component can comprise one or more patterned openings to be applied to a second side of the fabric.

10. The method of claim 6, wherein the fabric is cut to be used with at least one selected from a group consisting of a duvet, a duvet cover, a comforter, a quilt, a blanket, a fitted sheet, a flat sheet, a pillow case and/or pillow sham.

11. A bedding system comprising:
a fitted sheet wherein half of the fitted sheet is a solid color and half of the fitted sheet comprises a visual or textual pattern;
at least one flat sheet having a first end and second end and two sides, wherein half of the flat sheet is a solid color and half of the flat sheet includes a visual or textual pattern; and
at least one pillow case having two sides wherein one side is a solid color and one side includes a visual or textual pattern;
wherein both the first end and second end of the at least one flat sheet include a decorative hem.

12. A method of producing a bedding system comprising:
printing a pattern into one half of a sheet of fabric of a solid color;
cutting a fitted sheet, at least one flat sheet, and at least one pillow case from the sheet of fabric wherein the fitted sheet, the least one flat sheet, and the at least one pillow case are cut so that half is a solid color and half includes the printed pattern; and
stitching a decorative hem into a first end and a second end of at least one flat sheet.

13. The method of producing a bedding system of claim 12, wherein the sheet of fabric has a thread count between 144 and 1000.

14. The method of producing a bedding system of claim 12, wherein the decorative hem is one of a z-hem or double needle hem.

15. The method of producing a bedding system of claim 12, wherein the pattern is printed using a reactive printing method.

16. The method of producing a bedding system of claim 12, wherein the pattern is printed using a rotary printing machine.

17. The method of producing a bedding system of claim 12, wherein the pattern is printed using a digital printing machine.

18. The method of producing a bedding system of claim 12, further comprising providing the reconfigurable bedding component of claim 1.
